(19) United States
(12) Patent Application Publication
(10) Pub. No.: US 2024/0394581 A1
(43) Pub. Date: Nov. 28, 2024

(54) SURFACE CODE COMPUTATIONS WITH THREE COUPLERS PER QUBIT

(71) Applicant: Google LLC, Mountain View, CA (US)

(72) Inventor: Craig Gidney, Goleta, CA (US)

(21) Appl. No.: 18/411,597

(22) Filed: Jan. 12, 2024

Related U.S. Application Data
(60) Provisional application No. 63/479,635, filed on Jan. 12, 2023.

(51) Int. Cl. G06N 10/40; G06N 10/70

(52) U.S. Cl. CPC G06N 10/40; G06N 10/70

(57) ABSTRACT

Methods, systems, and apparatus for implementing a three coupler surface code cycle. In one aspect, a method includes, for a data qubit that is coupled to a first, second, and third measure qubit by a respective first, second, and third qubit coupler, measuring a first stabilizer by performing a first set of entangling operations between the data qubit and the first measure qubit using the first qubit coupler; measuring a second stabilizer by performing a second set of entangling operations between the data qubit and the second measure qubit using the second qubit coupler; measuring a third stabilizer by performing a third set of entangling operations between the data qubit and the third measure qubit using the third qubit coupler; and measuring a fourth stabilizer by performing a fourth set of entangling operations between the data qubit and the second measure qubit using the second qubit coupler.

### BACKGROUND

This specification relates to quantum computing.

Quantum computing provides a means to solve certain problems that cannot be solved in a reasonable period of time using conventional classical computers. These problems include factoring very large numbers into their primes and searching large, unstructured data sets. A number of physical systems are being explored for their use in quantum computing, including ions, spins in semiconductors, and superconducting circuits. However, none of these systems perform sufficiently well to serve directly as computational qubits. For example, single two-state physical systems, which can be used as physical qubits, cannot reliably encode and retain information for long enough to be useful.

Therefore, scalable quantum computers require quantum error correction. Classical error correction employs redundancy. For example, in the repetition code information is copied and stored multiple times. If the copies are later found to disagree, it can be determined that an error has occurred and a majority vote can be taken to recover the information. Copying quantum information is not possible due to the no-cloning theorem. Therefore, quantum error correction codes spread the logical information of one qubit onto an entangled state of multiple physical qubits. The multiple physical qubits are collectively referred to as a logical qubit.

Surface codes are a family of quantum error correcting codes that are defined on a two-dimensional grid of qubits. In the surface code, physical qubits are entangled using a sequence of physical qubit CNOT operations or other two qubit interactions such as CZ or Mølmer-Sørensen (sqrt ZZ) operations, with subsequent measurements of the entangled states providing a means for error correction and error detection. A set of physical qubits entangled in this way is used to define a logical qubit, which due to the entanglement and measurement has far better performance than the underlying physical qubits. One of the significant advantages of surface codes is their relative tolerance to local errors. Surface codes can handle error rates of almost 1% per surface code clock cycle. This error tolerance, along with the simple two-dimensional qubit layout, makes a surface code architecture a realistic approach to building a solid-state quantum computer.

### SUMMARY

This specification describes technologies for building the surface code with three couplers per qubit.

One innovative aspect of the subject matter described in this specification can be implemented in a method for performing a surface code cycle using a quantum computer comprising a plurality of qubits, the method comprising: for a data qubit in the plurality of qubits that is coupled to three measure qubits in the plurality of qubits, wherein the data qubit is coupled to a first measure qubit by a first qubit coupler, a second measure qubit by a second qubit coupler, and a third measure qubit by a third qubit coupler; measuring a first surface code stabilizer, comprising performing a first set of entangling operations between the data qubit and the first measure qubit using the first qubit coupler; measuring a second surface code stabilizer, comprising performing a second set of entangling operations between the data qubit and the second measure qubit using the second qubit coupler; measuring a third surface code stabilizer, comprising performing a third set of entangling operations between the data qubit and the third measure qubit using the third qubit coupler; and measuring a fourth surface code stabilizer, comprising performing a fourth set of entangling operations between the data qubit and the second measure qubit using the second qubit coupler.

Other implementations of these aspects include corresponding computer systems, apparatus, and computer programs recorded on one or more computer storage devices, each configured to perform the actions of the methods. A system of one or more classical and quantum computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations the first surface code stabilizer, the second surface code stabilizer, the third surface code stabilizer, and the fourth surface code stabilizer comprise ZZZZ or XXXX stabilizers.

In some implementations the first, second, third, and fourth set of entangling operations comprise CNOT operations.

In some implementations the first, second, third, and fourth set of entangling operations comprise CNOT operations and SWAP gates.

In some implementations the plurality of qubits is arranged as a hexagonal grid.

In some implementations the plurality of qubits is arranged as a square grid.

In some implementations the data qubit comprises a bulk data qubit.

In some implementations the first surface code stabilizer is measured in parallel to the second surface code stabilizer.

In some implementations the third surface code stabilizer is measured in parallel to the fourth surface code stabilizer and subsequent to the first surface code stabilizer and the second surface code stabilizer.

In some implementations at least one of the first, second, third, or fourth surface code stabilizers comprise a ZZZZ stabilizer, and wherein measuring the ZZZZ stabilizer comprises: performing a first CNOT gate on a first data qubit and a second data qubit, wherein the first data qubit acts as a control; performing a second CNOT gate on a third data qubit and a measure qubit for the ZZZZ stabilizer, wherein the third data qubit acts as a control; performing a third CNOT gate on the second data qubit and the measure qubit for the ZZZZ stabilizer, wherein the second data qubit acts as a control; measuring the measure qubit for the ZZZZ stabilizer in the Z basis; performing a fourth CNOT gate on the second data qubit and the measure qubit for the ZZZZ stabilizer, wherein the second data qubit acts as a control; performing a fifth CNOT gate on the third data qubit and the measure qubit for the ZZZZ stabilizer, wherein the third data qubit acts as a control; and performing a sixth CNOT gate on the first data qubit and the second data qubit, wherein the first data qubit acts as a control; wherein the data qubit in the plurality of qubits is either the first, second, or third data qubit.

In some implementations at least one of the first, second, third, or fourth surface code stabilizers comprise a XXXX stabilizer, and wherein measuring the XXXX stabilizer comprises: performing a first CNOT gate on a measure qubit for the XXXX stabilizer and a first data qubit, wherein the measure qubit for the XXXX stabilizer acts as a control; performing a second CNOT gate on a second data qubit and a third data qubit, wherein the second data qubit acts as a control; performing a third CNOT gate on the measure qubit for the XXXX stabilizer and the second data qubit, wherein the measure qubit for the XXXX stabilizer acts as a control; measuring the measure qubit for the XXXX stabilizer in the X basis; performing a fourth CNOT gate on the measure qubit for the XXXX stabilizer and the second data qubit, wherein the measure qubit for the XXXX stabilizer acts as a control; performing a fifth CNOT gate on the second data qubit and the third data qubit, wherein the second data qubit acts as a control; and performing a sixth CNOT gate on the measure qubit for the XXXX stabilizer and the first data qubit, wherein the measure qubit for the XXXX stabilizer acts as a control; wherein the data qubit in the plurality of qubits is either the first, second, or third data qubit.

In some implementations at least one of the first, second, third, or fourth surface code stabilizers comprise a XXXX stabilizer and at least one of the first, second, third, or fourth surface code stabilizers comprise a ZZZZ stabilizer, wherein measuring the XXXX stabilizer and the ZZZZ stabilizer comprises: performing a first CNOT gate on a first measure qubit and a first data qubit, wherein the first measure qubit acts as a control; performing a second CNOT gate on a second data qubit and a third data qubit, wherein the second data qubit acts as a control; performing a third CNOT gate on a fourth data qubit and a second measure qubit, wherein the fourth data qubit acts as a control; performing a fourth CNOT gate on the first measure qubit and the second data qubit, wherein the first measure qubit acts as a control; performing a fifth CNOT gate on the third data qubit and the second measure qubit, wherein the third data qubit acts as a control; measuring the first measure qubit in the X basis and the second measure qubit in the Z basis; performing a sixth CNOT gate on the third data qubit and the second measure qubit, wherein the third data qubit acts as a control; performing a seventh CNOT gate on the first measure qubit and the second data qubit, wherein the first measure qubit acts as a control; performing a eighth CNOT gate on the fourth data qubit and the second measure qubit, wherein the fourth data qubit acts as a control; performing a ninth CNOT gate on the second data qubit and the third data qubit, wherein the second data qubit acts as a control; and performing a tenth CNOT gate on the first measure qubit and the first data qubit, wherein the first measure qubit acts as a control; wherein the data qubit in the plurality of qubits is either the first, second, third, or fourth data qubit the first measure qubit is a measure qubit for the XXXX stabilizer, and the second measure qubit is a measure qubit for the ZZZZ stabilizer.

Another innovative aspect of the subject matter described in this specification can be implemented in a method for performing a surface code cycle, the method comprising: for a quantum computer comprising an array qubits, wherein each qubit in the array of qubits is coupled to at most three other qubits in the array of qubits: measuring a first column of alternating XXXX and ZZZZ stabilizers in the array of qubits; measuring a second column of alternating XXXX and ZZZZ stabilizers in the array of qubits, wherein the second column is adjacent to the first column and the XXXX and ZZZZ stabilizer measurements in the second column vertically mirror the XXXX and ZZZZ stabilizer measurements in the first column.

Other implementations of these aspects include corresponding computer systems, apparatus, and computer programs recorded on one or more computer storage devices, each configured to perform the actions of the methods. A system of one or more classical and quantum computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The subject matter described in this specification can be implemented in particular ways so as to realize one or more of the following advantages.

The presently described three coupler surface code can be performed using a same number of qubit interaction layers as conventional surface codes but only uses three couplers per qubit instead of four. Therefore, implementations of the presently described three coupler surface code is less resource intensive compared to implementations of conventional surface codes. In addition, the presently described surface code is suitable for a larger range of quantum devices, e.g., devices with limited qubit connectivity such as devices that include hex/honeycomb grids.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system for implementing a three coupler surface code.

FIG. 2 shows example circuits for measuring ZZZZ and XXXX stabilizers.

FIG. 3 is a block diagram of an example circuit schedule for measuring a column of alternating XXXX and ZZZZ stabilizers.

FIG. 4 is a block diagram of an example circuit schedule for measuring a column of alternating XXXX and ZZZZ stabilizers using iSWAP-like interactions.

FIG. 5 is a block diagram that shows the couplers used to measure multiple columns of alternating XXXX and ZZZZ stabilizers.

FIG. 6 is a flowchart of an example process for performing a three coupler surface code cycle.

FIG. 7 is a block diagram that shows example CNOT interaction cycles performed during a three coupler surface code cycle on an array of qubits.

FIG. 8A compares the physical qubit layouts required for a conventional rotated surface code and the presently described three coupler surface code.

FIG. 8B compares the number of interaction layers required for conventional surface code implementations and the presently described three coupler surface code.

FIG. 9A compares the detection region of a conventional rotated surface code and the presently described three coupler surface code when implemented using CZ entangling operations.

FIG. 9B compares the detection region of a conventional rotated surface code and the presently described three coupler surface code when implemented using iSWAP entangling operations.

FIG. 10 shows a table that compares values of various surface code metrics.

FIG. 11 depicts an example quantum computer.

FIGS. 12-17 illustrate example circuit schedules for performing surface code cycles using the techniques described in the present disclosure.

Like reference numbers and designations in the various drawings indicate like elements.

### DETAILED DESCRIPTION

This specification describes circuit schedules for implementing the surface code using at most three couplers per qubit.

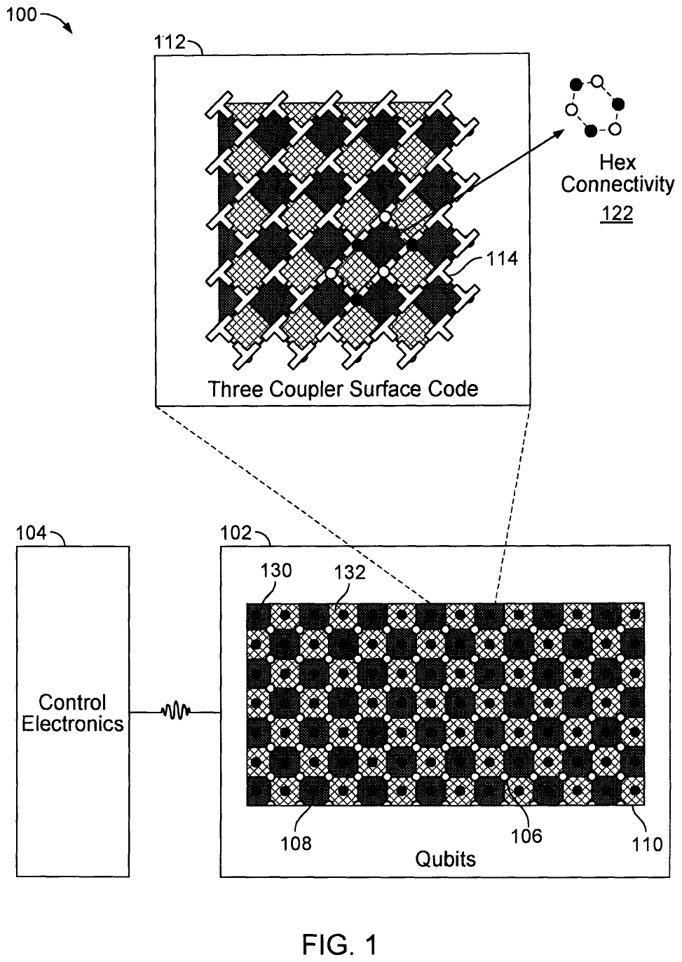

FIG. 1 is a block diagram of an example system for implementing a three coupler surface code. The example system 100 is an example of a system implemented as part of a quantum computing device in which the systems, components and techniques described in this specification can be implemented.

The system 100 includes multiple qubits 102 in communication with control electronics 104. The qubits 102 are physical qubits, e.g., physical devices that behave as a quantum system with at least two states. Each qubit can be in a respective quantum state that occupies one or more levels. The levels can include at least two computational levels, e.g., levels 0− and 1−, and one or more non-computational levels that are each higher than the computational qubit levels, e.g., levels 2− and 3−. Population of the higher, non-computational qubit levels can introduce errors in algorithmic operations or quantum computations performed using the qubit. For example, the occupation of qubit levels outside the computational subspace can hamper or prevent the implementation of quantum error correction operations.

In some implementations the qubits 102 can be superconducting qubits or semiconducting qubits. For example, the qubits 102 can include Xmon qubits, flux qubits, phase qubits, or qubits with frequency interactions. Generally, the qubits 102 are physical devices that are configured to meet basic requirements for quantum computation. For example, the qubits 102 include physical devices that can be initialized, can perform single-qubit rotations, can participate in two-qubit entangling operations, e.g., controlled-NOT (CNOT) gates, can perform a topological version of the Hadamard transformation, e.g., by exchanging their quantum states in a SWAP operation, and can be measured.

The qubits 102 can be arranged in an array. For example, as shown in FIG. 1, in some implementations the qubits 102 can be arranged as a two dimensional array, such as a square grid 110. The example two dimensional grid 110 depicted in FIG. 1 includes 11×7=77 qubits, however in some implementations the system 100 may include a smaller or a larger number of qubits. In other implementations the qubits 102 can be arranged on another shaped grid, e.g., a hexagonal grid.

The qubits 102 can interact with each other through multiple qubit couplers. The qubit couplers can define nearest neighbor interactions between qubits, e.g., such that in a square grid each qubit interacts with at most four neighboring qubits or in a hexagonal grid each qubit interacts with at most three neighboring qubits. The couplers can, in principle, be any type of coupler, e.g., a capacitive or inductive coupler. In some implementations the strengths of the couplers can be controllable, e.g., frequency controllable. In other implementations the couplers can be couplers with a fixed coupling strength.

The control electronics 104 include control devices, e.g., arbitrary waveform generators, that can operate the multiple qubits 102. For example, the control electronics 104 can include control devices that tune operating frequencies of the qubits 102 by applying control signals, e.g., voltage pulses, to the qubits through respective control lines.

As another example, the control electronics 104 can control individual frequencies of the qubits 102 such that the frequency of one or more of the qubits are adjusted towards or away from a frequency of an excitation pulse generated by an excitation pulse generator on an excitation driveline. The excitation pulses can include pulses with frequencies that implement quantum operations, e.g., quantum logic gates. The qubits 102 can be coupled to one or more excitation drivelines via respective couplers. In some cases, the couplers can be capacitive couplers, e.g., realized by a microwave line running adjacent to a qubit capacitor.

The control electronics 104 can also include control devices that tune frequencies of the couplers that couple the multiple qubits 102.

The type of control electronics 104 that the system 100 utilizes is dependent on the type of qubits the system uses. As an example, qubits that are realized via atomic, molecular or solid-state quantum systems typically have energy separation of the relevant qubit levels in the microwave or optical domain. The states of such qubits may be manipulated and controlled using external fields, such as microwave or optical fields. In such cases, as an example, mode-locked lasers may serve as control electronics due to their broad-band optical spectra that feature both radio frequency and microwave structure. In another example, the control electronics 104 could include a collection of individual qubit controllers realized by a radio frequency generator as well as one or a collection of global excitation controllers realized by a radio frequency or microwave generator. In both cases, the control electronics 104 can be operated manually or connected to a computer (e.g., a classical computer) and controlled via suitable software allowing for specifying and automatically running the required qubit operations.

The system 100 can program the control electronics 104 to implement the surface code. To implement the surface code, each qubit in the multiple qubits 102 has one of two functional types: data qubits, e.g., qubit 106, and measure qubits, e.g., qubit 108. A data qubit, e.g., qubit 106, is a qubit that participates in quantum computations performed by the system 100 and stores quantum information corresponding to the quantum computations. That is, the state of the data qubit encodes logical information for a quantum computation. A measure qubit is a qubit that is used to determine an outcome of a computation performed by the data qubit. For example, during a computation an unknown state of the data qubit can be entangled with the state of the measure qubit using a suitable physical operation, after which the measure qubit can be measured. The measure qubits can include measure-X qubits, e.g., measure qubits located in a center of a lighter grey square such as square 132, and measure-Z qubits, e.g., measure qubits located in a center of a darker grey square such as square 130.

In conventional implementations of the surface code (different to the implementations described in this disclosure), each data qubit is directly coupled to multiple measure qubits (and is not directly coupled to any other data qubits) and each measure qubit is directly coupled to multiple data qubits (and is not directly coupled to any other measure qubits). For example, each measurement qubit is coupled to four data qubits (if the measure qubit is in the bulk, if it is at the boundary it is coupled to less data qubits). Each data qubit is coupled to two measure-Z qubits and to two measure-X qubits (if the data qubit is at in the bulk, if the data qubit is at the boundary it is coupled to less measure qubits). Therefore, conventional implementations of the surface code typically assume that the quantum hardware includes a square grid of qubits with four couplers per qubit (in the bulk).

A measure-Z qubit is a qubit that can be used to force its neighboring data qubits a, b, c and d into an eigenstate of the operator product \hat{Z}ₐ\hat{Z}_{b}\hat{Z}_{c}\hat{Z}_{d} where \hat{Z}ₐ represents a Pauli-Z operator acting on qubit a. Each measure-Z qubit is therefore described as measuring a ZZZZ stabilizer. In the example array 102 of FIG. 1, ZZZZ stabilizers are represented by darker grey squares, e.g., square 130, where data qubits exist at the vertices of the ZZZZ stabilizers and measure-Z qubits exist at the center of each ZZZZ stabilizer. A measure-X qubit is a qubit that can be used to force its neighboring data qubits a, b, c and d into an eigenstate of the operator product \hat{X}ₐ\hat{X}_{b}X_{c}\hat{X}_{d} where \hat{X}ₐ represents a Pauli-X operator acting on qubit a. Each measure-X qubit is therefore referred to as measuring a XXXX stabilizer. In the example array 102 of FIG. 1, XXXX stabilizers are represented by lighter grey squares, e.g., square 132, where data qubits exist at the vertices of the XXXX stabilizers and measure-X qubits exist at the center of each XXXX stabilizer.

In conventional implementations of the surface code, the control electronics 104 operate the measure-Z and measure-X qubits by repeatedly applying a quantum circuit to the measure-Z and measure-X qubits and their neighboring data qubits. Each application of a quantum circuit performs one surface code cycle. Each quantum circuit includes a sequence of operations applied to one or more physical qubits. In examples, first the measure qubit is initialized, e.g., in its ground state. Then, four entangling operations, e.g., CNOT gates or CZ gates, are performed. For a measure-Z qubit, each of the four entangling operations targets the measure qubit and each nearest-neighbor data qubit acts as a control for a respective entangling operation. For a measure-X qubit, each of the four entangling operations targets a respective nearest-neighbor data qubit and the measure-X qubit acts as a control for each of the four entangling operations. In this case, the sequence of operations also includes a Hadamard gate applied to the measure qubit before and after the entangling operations. As described above, conventional implementations of the surface code typically assume that the quantum hardware includes a square grid of qubits with four couplers per qubit (in the bulk), where each of the four couplers is used to perform a respective entangling operation. After the entangling operations are performed, the measure qubit is measured, e.g., through projective measurement. Following the measurement, a subsequent surface code cycle is performed.

Unlike conventional implementations of the surface code, the presently described implementations of the surface code use circuit schedules that require at most three couplers per qubit-without increasing the number of layers of entangling operations. The presently described surface code is therefore referred to herein as a “three coupler surface code.” As described in more detail below, the three coupler surface code cycle is implemented by measuring a first column of alternating XXXX and ZZZZ stabilizers in the array of qubits and then measuring a second column of alternating XXXX and ZZZZ stabilizers in the array of qubits, where the second column is adjacent to the first column and the XXXX and ZZZZ stabilizer measurements in the second column vertically mirror the XXXX and ZZZZ stabilizer measurements in the first column (that is stabilizer measurements in the first and second column include a respective series of measurements obtained along a path in the qubit array, where when the path of the second column is juxtaposed against the first column, the second column appears to be reflected across a vertical plane).

FIG. 1 shows an example three coupler surface code qubit layout 112. As shown, each measure qubit and data qubit (in this example positioned at vertices of the XXXX and ZZZZ stabilizers) is coupled to three other qubits via respective couplers, e.g., couplers 114. The three coupler surface code can therefore be implemented on square grids, e.g., by turning some nearest neighbor couplers off, or can be implemented on devices with hex grid connectivity 122 (where qubits have 2 or 3 neighbors and no 3-neighbor qubits are adjacent).

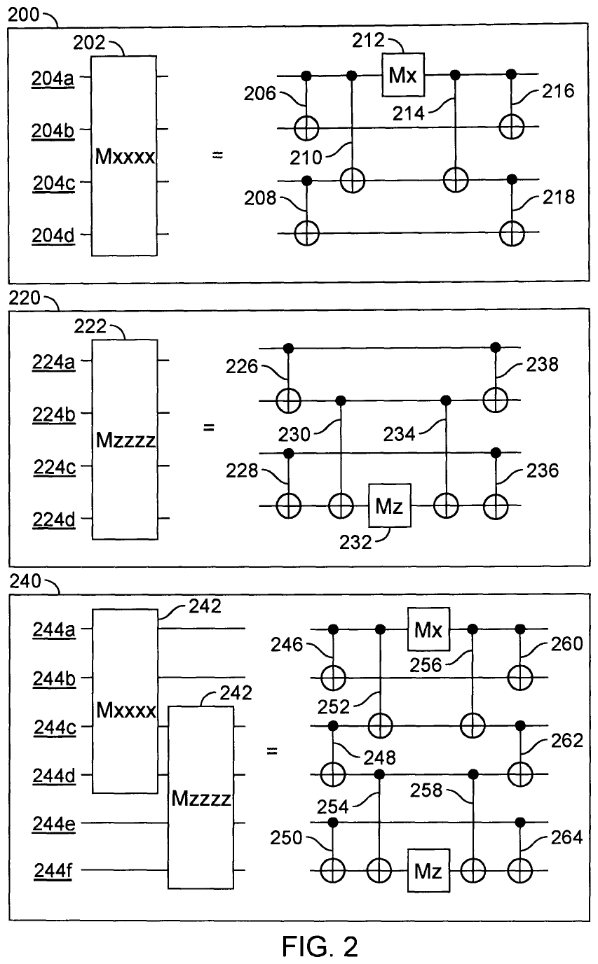

FIG. 2 shows example circuits 200, 220, and 240 for measuring XXXX and ZZZZ stabilizers. The example circuits 200, 220, and 240 form the basis of the presently described three coupler surface code.

Example circuit 200 shows a sequence of operations for measuring a XXXX stabilizer 202 using one measure qubit 204a and three data qubits 204b, 204c, and 204d. After the measure qubit 204a is initialized (not shown in FIG. 2), a first CNOT gate 206 is applied to the measure qubit 204a and the data qubit 206b, where the measure qubit 204a acts as a control. In the present disclosure applying a CNOT gate can include applying a set of quantum operations that has the effect of performing a CNOT operation, e.g., where the set of operations depends on the specific quantum hardware being used to perform the quantum computations. For example, in some implementations the system can apply a CNOT gate indirectly using combinations of CZ gates and Hadamard gates.

A second CNOT gate 208 is applied to the data qubit 204c and the data qubit 204d, where the data qubit 204c acts as a control. A third CNOT gate is applied to the measure qubit 204a and the data qubit 204c, where the measure qubit acts as a control. The measure qubit 204a is measured in the X basis through application of a measurement operation 212. A fourth CNOT gate 214 is applied to the measure qubit 204a and the data qubit 204c, where the measure qubit acts as a control. A fifth CNOT gate 218 is applied to the data qubit 204c and the data qubit 204d, where the data qubit 204c acts as a control. A sixth CNOT gate 216 is applied to the measure qubit 204a and the data qubit 206b, where the measure qubit 204a acts as a control.

Example circuit 220 shows a sequence of operations for measuring a ZZZZ stabilizer 222 using three data qubits 224a, 224b, and 224c and one measure qubit 224d. After the measure qubit 224d is initialized (not shown in FIG. 2), a first CNOT gate 226 is applied to the data qubit 224a and the data qubit 224b, where the first qubit 224a acts as a control. A second CNOT gate 228 is applied to the data qubit 224c and the measure qubit 224d, where the qubit 224c acts as a control. A third CNOT gate 230 is applied to the data qubit 224b and the measure qubit 224d, where the data qubit 224b acts as a control. The measure qubit 224d is measured in the Z basis through application of a measurement operations 232. A fourth CNOT gate 234 is applied to the data qubit 224b and the measure qubit 224d, where the data qubit 224b acts as a control. A fifth CNOT gate 236 is applied to the data qubit 224c and the measure qubit 224d, where the qubit 224c acts as a control. A sixth CNOT gate 238 is applied to the data qubit 224a and the data qubit 224b, where the first qubit 224a acts as a control.

Example circuit 240 shows a sequence of operations for measuring an overlapping XXXX and ZZZZ stabilizer 242 using a first measure qubit 244a, four data qubits 244b, 244c, 244d, and 244e, and a second measure qubit 244f. After the measure qubits 244a and 244f are initialized (not shown in FIG. 2), a first CNOT gate 246 is applied to the first measure qubit 244a and the data qubit 244b, where the measure qubit 244a acts as a control. A second CNOT gate 248 is applied to the data qubit 244c and the data qubit 244d, wherein the data qubit 244c acts as a control. A third CNOT gate 250 is applied to the data qubit 244e and the second measure qubit 244f, where the data qubit 244e acts as a control. A fourth CNOT gate is applied to the first measure qubit 244a and the data qubit 244c, where the first measure qubit 244a acts as a control. A fifth CNOT gate 254 is applied to the data qubit 244d and the second measure qubit 244f, where the data qubit 244d acts as a control. The first measure qubit 244a is measured in the X basis and the second measure qubit 244f is measure in the Z basis. A sixth CNOT gate 258 is applied to the data qubit 244d and the second measure qubit 244f, where the data qubit 244d acts as a control. A seventh CNOT gate 256 is applied to the first measure qubit 244a and the data qubit 244c, where the first measure qubit 244a acts as a control. An eighth CNOT gate 264 is applied to the data qubit 244e and the second measure qubit 244f, where the data qubit 244e acts as a control. A ninth CNOT gate 262 is applied to the data qubit 244c and the data qubit 244d, wherein the data qubit 244c acts as a control. A tenth CNOT gate 260 is applied to the first measure qubit 244a and the data qubit 244b, where the measure qubit 244a acts as a control.

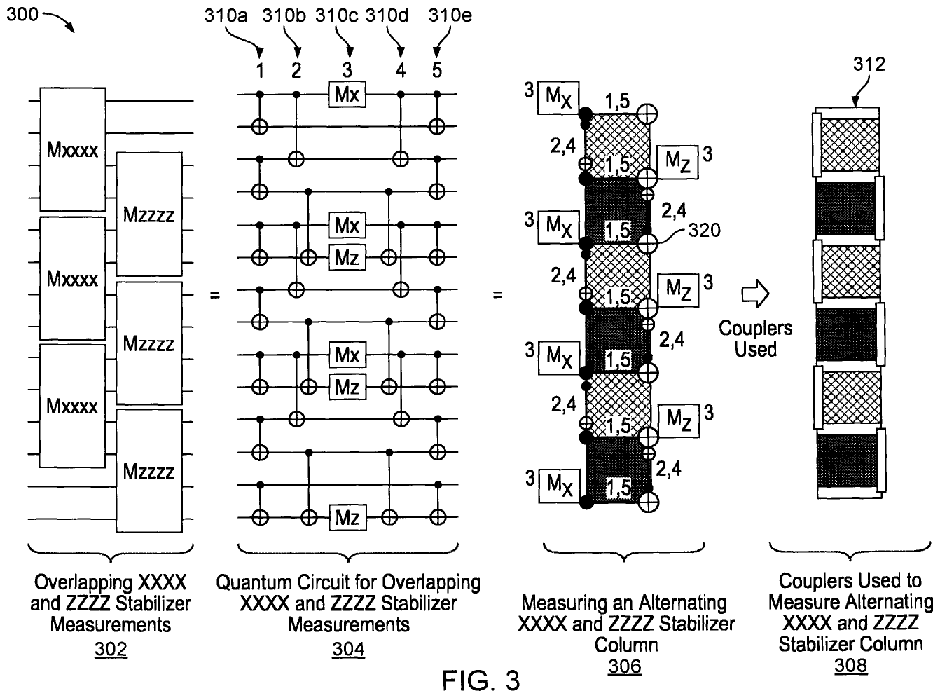

FIG. 3 is a block diagram 300 of an example circuit schedule for measuring a column of alternating XXXX and ZZZZ stabilizers. As described above with reference to FIG. 2, the individual quantum circuits 200 and 220 for measuring a XXXX stabilizer and a ZZZZ stabilizer can be overlapped to produce the quantum circuit 240 for measuring an overlapping XXXX and ZZZZ stabilizer. In turn, the quantum circuit 240 can be overlapped to produce the quantum circuit 340 for measuring a column of overlapping XXXX and ZZZZ stabilizers 302. For brevity, the column of overlapping XXXX and ZZZZ stabilizers 302 includes three XXXX stabilizers and three ZZZZ stabilizers, however the presently described techniques can be extended to form columns that include a larger number of overlapping XXXX and ZZZZ stabilizers.

The sequence of operations included in example circuit 304 can be separated into 5 layers of operations 310a-e. In the first layer 310a, multiple CNOT gates are applied to pairs of qubits. The CNOT gates in the first layer 310a correspond to CNOT gates 246, 248, and 250 in FIG. 2. In the second layer 310b, multiple CNOT gates are applied to pairs of qubits. The CNOT gates in the second layer 310b correspond to gates 252 and 254 in FIG. 2. In the third layer 310c, each measure-X qubit and each measure-Z qubit are measured (in the X basis and Z basis, respectively). In the fourth layer 310d, multiple CNOT gates are applied to pairs of qubits. The CNOT gates in the fourth layer 310d correspond to CNOT gates 256 and 258 in FIG. 2. In the fifth layer 310e, multiple CNOT gates are applied to pairs of qubits. The CNOT gates in the fifth layer 310e correspond to CNOT gates 260, 262, and 264 in FIG. 2. As in example circuits 200, 220, and 240 of FIG. 2, the fourth layer 310d mirrors the second layer 310b and the fifth layer 310e mirrors the first layer 310a. The four layers 310a, 310b, 310d, and 310e each include two qubit gates that cause interactions between qubits and are therefore referred to as interaction layers.

The layers of operations 310a-e can be implemented according to example circuit schedule 306 to measure a column of alternating XXXX and ZZZZ stabilizers in a physical device, e.g., a device that includes an array of qubits as described in FIG. 1. In the example shown in FIG. 3, it is assumed that measure-X qubits are located at the top left corners of the XXXX stabilizers (darker grey squares e.g., square 322) and that measure-Z qubits are located at the top right corners of the ZZZZ stabilizers (lighter grey squares e.g., square 324). However, flipping inner CNOT gates (e.g., those performed at steps 2 and 4 described below) can flip the role of the qubits such that the measure-X qubits are located at the bottom left corners of the XXXX stabilizers and the measure-Z qubits are located at the bottom right corners of the ZZZZ stabilizers. In either case, the couplers used to measure the column of alternating XXXX and ZZZZ stabilizers 308 remains the same.

In the first step of the circuit schedule 306, the CNOT gates in layer 310a are performed. This includes performing a CNOT gate between each measure-X qubit and a data qubit to which the measure-X qubit is coupled (in this non-limiting example, the data qubit to the right of the measure-X qubit in the array of qubits), where the measure-X qubit acts as a control. In parallel, a CNOT gate is performed between each measure-Z qubit and a data qubit to which the measure-Z qubit is coupled (in this non-limiting example, the data qubit to the left of the measure-Z qubit in the array of qubits), where the measure-Z qubit acts are the target. These operations are labelled “1” in the example circuit schedule 306.

In the second step of the circuit schedule 306, the CNOT gates in layer 310b are performed. This includes performing a CNOT gate between each measure-X qubit and another data qubit to which the measure-X is coupled (in this non-limiting example, the data qubit below the measure-X qubit in the array of qubits), where the measure-X qubit acts as a control. In parallel, a CNOT gate is performed between each measure-Z qubit and another data qubit to which the measure-Z qubit is coupled (in this non-limiting example, the data qubit below the measure-Z qubit in the array of qubits), where the measure-Z qubit acts are the target. These operations are labelled “2” in the example circuit schedule 306.

In the third step of the circuit schedule 306, measurement operations are performed on each measure-X qubit and each measure-Z qubit. These operations are labelled “3” in the example circuit schedule 306.

The fourth step of the circuit schedule 306 is the same as the second step of the circuit schedule 306. The operations included in the fourth step are labelled “4” in the example circuit schedule 306. The fifth step of the circuit schedule 306 is the same as the first step of the circuit schedule 306. The operations included in the fifth step are labelled “5” in the example circuit schedule 306.

As shown, it is not required that each data qubit (or each measure qubit) is coupled to each of its neighboring measure qubits (or data qubits) to measure the column of alternating XXXX and ZZZZ stabilizers using example circuit schedule 304. Instead, the example circuit schedule 304 uses a path of couplers 308, e.g., including coupler 312, that winds through the column.

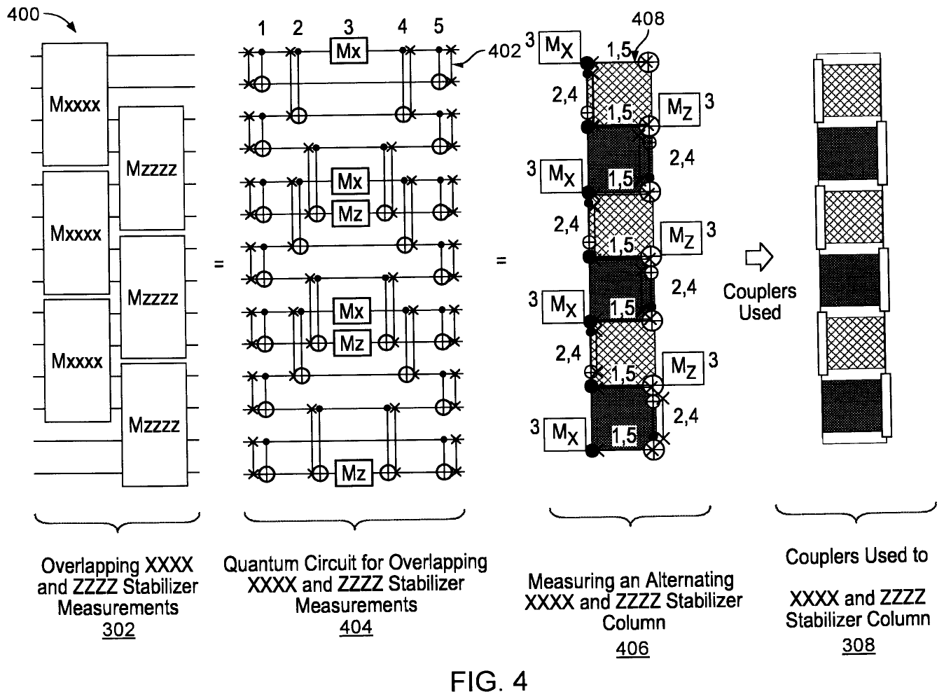

FIG. 4 is a block diagram 400 of an example circuit schedule 406 for measuring a column of alternating XXXX and ZZZZ stabilizers using iSWAP-like interactions. In some hardware settings, iSWAP gates can be easier to implement than two qubit gates such as CNOT gates or CZ gates, e.g., because CZ gates can introduce more calibration constraints than iSWAP gates.

In this example, the column of overlapping XXXX and ZZZZ stabilizers 302 is measured using quantum circuit 404. Quantum circuit 404 is similar to quantum circuit 304 of FIG. 3, except that in layers 1 and 2, each CNOT gate is preceded by a SWAP gate that is applied to the same qubits as the CNOT gate (where under the KAK decomposition a SWAP gate preceding a CNOT or CZ gate have a same interaction as an iSWAP gate and single qubit gates can be included such that the SWAP gate and CNOT/CZ are equal to an iSWAP). In layers 4 and 5, each CNOT gate is followed by a SWAP gate that is applied to the same qubits as the CNOT gate, e.g., SWAP gate 402. In addition, the example circuit schedule 406 is similar to example circuit schedule 304 of FIG. 3, except that SWAP gates are also performed at steps “1”, “2”, “4” and “5”. The couplers used to measure the column of alternating XXXX and ZZZZ stabilizers 308 is the same as in FIG. 3.

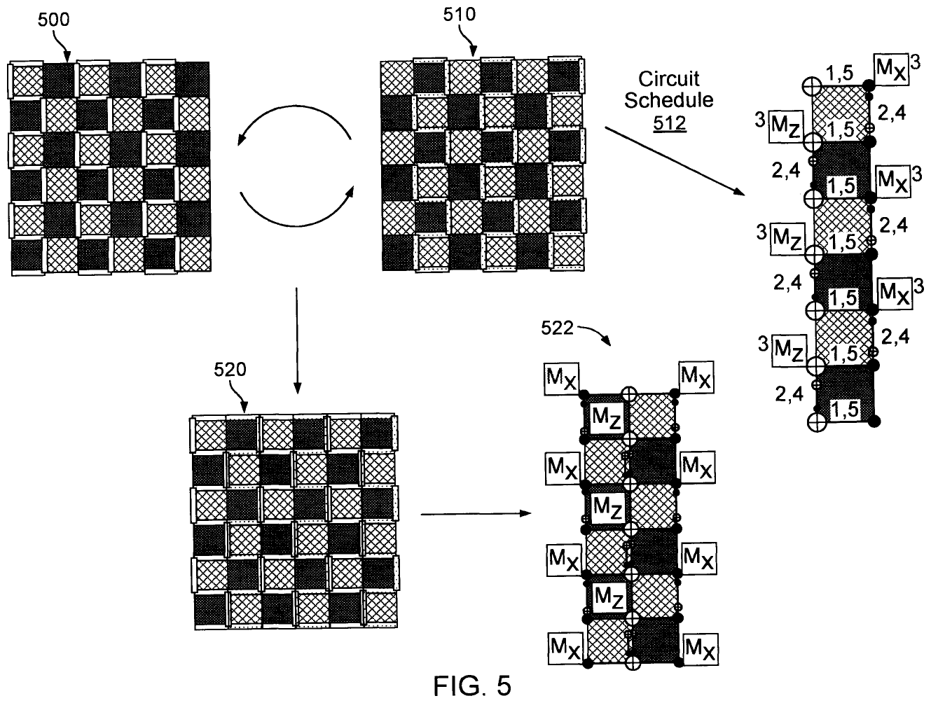

FIG. 5 is a block diagram that shows the couplers used to measure multiple columns of alternating XXXX and ZZZZ stabilizers. The coupler path used to measure one column of alternating XXXX and ZZZZ stabilizers, as described above with reference to FIG. 3, can be repeated throughout the array of qubits in the physical device to measure multiple columns in the array. Since packing the coupler paths together such that stabilizers in every column in the array are measured according to the circuit schedule 306 of FIG. 3 would cause the columns to interfere with each other, the coupler paths can be used to measure stabilizers in every other column of the array, as shown in box 500 of FIG. 5.

To measure the stabilizers in the remaining columns of the array without causing interference between columns, additional coupler paths that mirror (along the vertical) the coupler paths shown in FIG. 3 can be added to the array, as shown in box 510. The additional coupler paths 510 correspond to a circuit schedule 512 that is similar to the circuit schedule 306 of FIG. 3, where the direction of operations included in the layers of operations are also mirrored, e.g., in the first step “1” of the schedule 512 a CNOT gate is performed between each measure-X qubit in the column and a data qubit to the left of the measure-X qubit instead of the right.

Combining the coupler paths (and underlying circuit schedules) shown in boxes 500 and 510 produces the coupler configuration shown in box 520. As shown, this configuration enables each stabilizer (in the bulk) to be measured using at most three couplers per qubit.

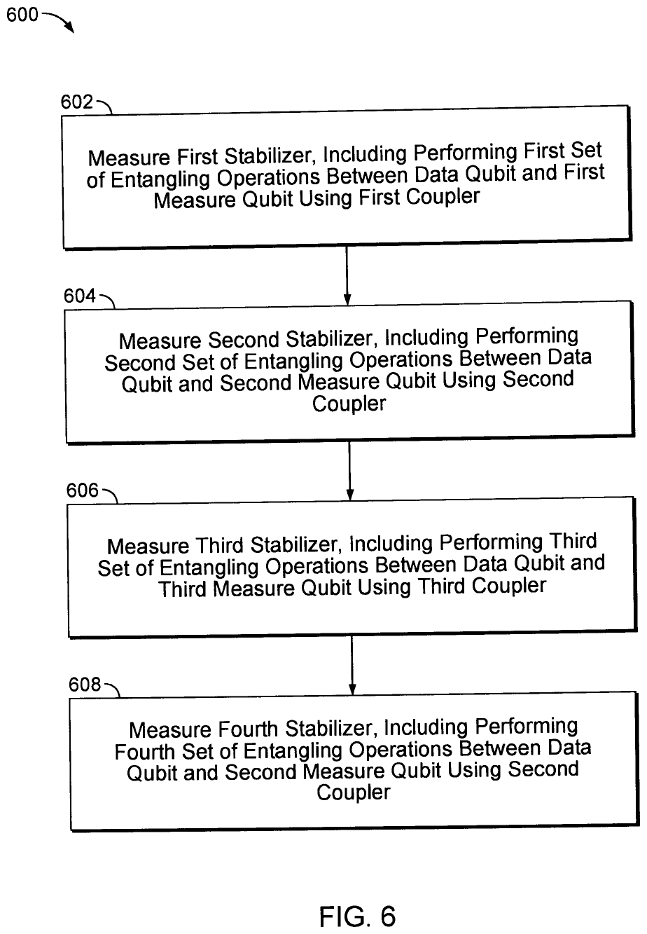

FIG. 6 is a flowchart of an example process 600 for performing a three coupler surface code cycle. For convenience, the process 600 will be described as being performed by components of a quantum computing system. For example, classical control electronics in communication with an array of physical qubits, e.g., the control electronics 104 of FIG. 1, appropriately programmed, can perform example process 600. The array of physical qubits can be arranged as a square grid or as a hexagonal grid.

For clarity, example process 600 is described with reference to performing a three coupler surface code cycle on one (bulk) data qubit that is coupled to a first measure qubit by a first qubit coupler, a second measure qubit by a second qubit coupler, and a third measure qubit by a third qubit coupler. However, example process 600 can be performed (in parallel) for each of multiple data qubits (and their neighboring measure qubits) included in a surface code patch.

The system measures a first surface code stabilizer (step 602). Measuring the first surface code stabilizer includes performing a first set of entangling operations, e.g., CNOT gates or CNOT gates and SWAP gates, between the data qubit and the first measure qubit using the first qubit coupler. For example, referring to the data qubit 320 of FIG. 3, measuring the first surface code stabilizer includes performing the entangling operations at steps 1, 5 with the measure-X qubit to the left of the data qubit 320.

The system measures a second surface code stabilizer (step 604). Measuring the second surface code stabilizer includes performing a second set of entangling operations, e.g., CNOT gates or CNOT gates and SWAP gates, between the data qubit and the second measure qubit using the second qubit coupler. For example, referring to the data qubit 320 of FIG. 3, measuring the second surface code stabilizer includes performing the entangling operations at steps 2, 4 with the measure-Z qubit above the data qubit 320. Measuring the first and second surface code stabilizers at steps 602 and 604 correspond to operations that are performed to measure a column of alternating stabilizers, e.g., as shown in FIG. 5.

The system measures a third surface code stabilizer (step 606). Measuring the third surface code stabilizer includes performing a third set of entangling operations, e.g., CNOT gates or CNOT gates and SWAP gates, between the data qubit and the third measure qubit using the third qubit coupler. For example, referring to the data qubit 320 of FIG. 3, measuring the third surface code stabilizer would include performing entangling operations with a measure-X qubit to the right of the data qubit 320.

The system measures a fourth surface code stabilizer (step 608). Measuring the fourth surface code stabilizer includes performing a fourth set of entangling operations, e.g., CNOT gates or CNOT gates and SWAP gates, between the data qubit and the second measure qubit using the second qubit coupler. For example, referring to the data qubit 320 of FIG. 3, measuring the third surface code stabilizer would include performing another set of entangling operations with the measure-Z qubit above the data qubit 320. Measuring the third and fourth surface code stabilizers at steps 606 and 608 correspond to operations that are performed to measure a column of alternating stabilizers, e.g., as shown in FIG. 5.

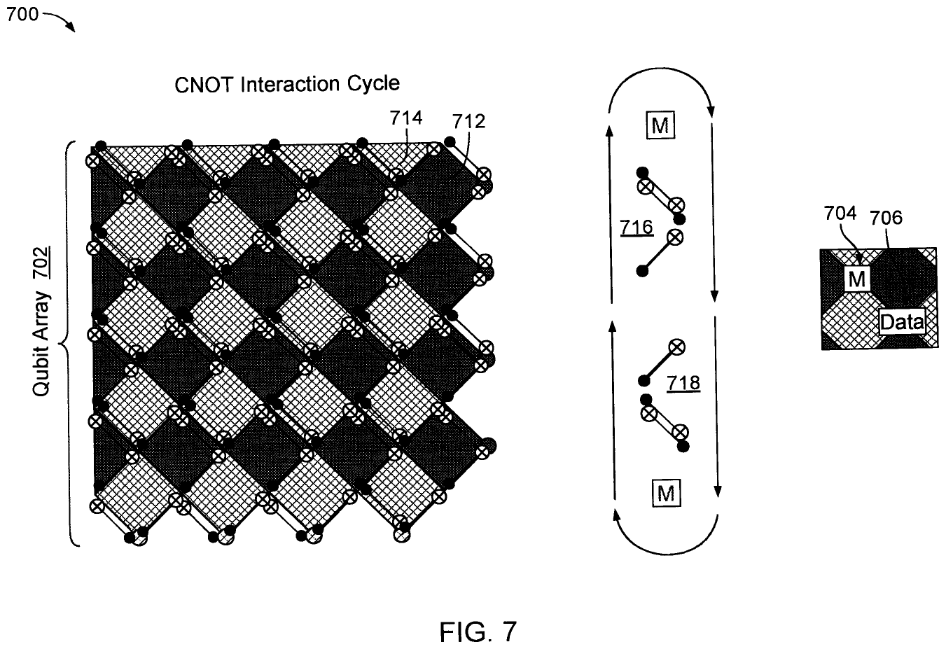

FIG. 7 is a block diagram 700 that shows example CNOT interaction cycles performed during a three coupler surface code cycle on an array of qubits 702. In this example, measure qubits 704 are located at the bottom vertices of the stabilizers corresponding to the lighter grey squares, e.g., square 714, and data qubits 706 are located at the bottom vertices of the stabilizers corresponding to the darker grey squares, e.g., square 712.

In the example shown in FIG. 7, CNOT gates 716 correspond to CNOT interactions performed in a first step using, e.g., the path of couplers 308 shown in FIG. 3. CNOT gates 718 correspond to CNOT interactions performed in a second step using, e.g., the path of couplers 510 shown in FIG. 5.

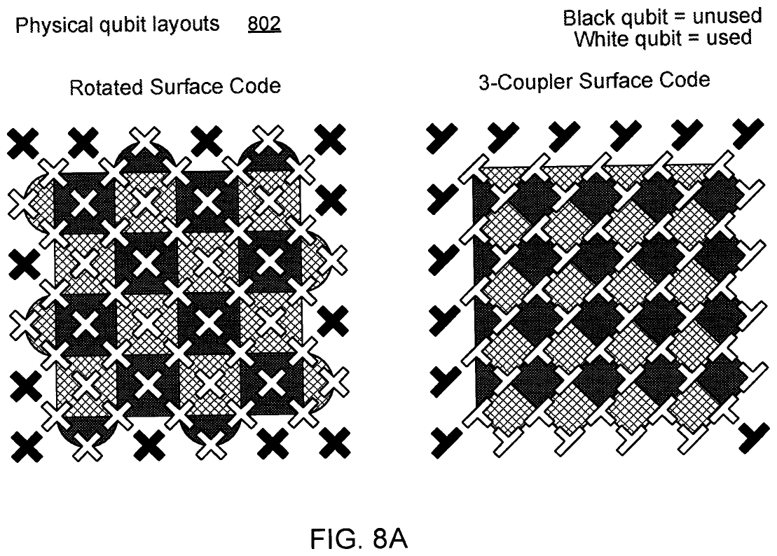

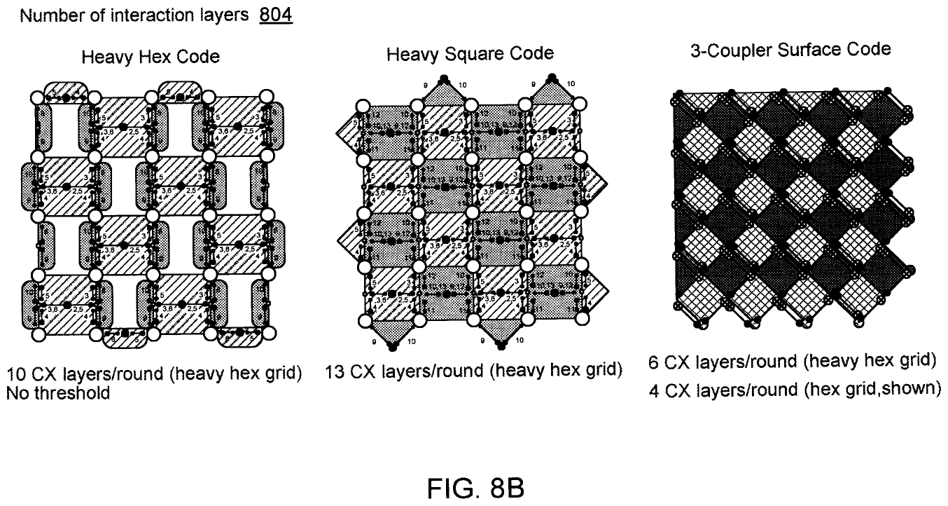

FIG. 8A compares the physical qubit layouts 802 required for a conventional rotated surface code and the presently described three coupler surface code. As shown, conventional rotated surface codes require four couplers per qubit, whereas the presently described three coupler surface code requires only three couplers per qubit.

FIG. 8B compares the number of interaction layers 804 required (per cycle/round) for conventional surface code implementations and the presently described three coupler surface code. The heavy hex code requires 10 interaction layers per round (when implemented on a heavy hex grid of qubits). The heavy square code requires 13 interaction layers per round (when implemented on a heavy hex grid of qubits). The presently described three coupler surface code requires only 6 interaction layers per round when implemented on a heavy hex grid of qubits, and requires only 4 interaction layers per round when implemented on a hex grid of qubits, as shown in FIG. 7.

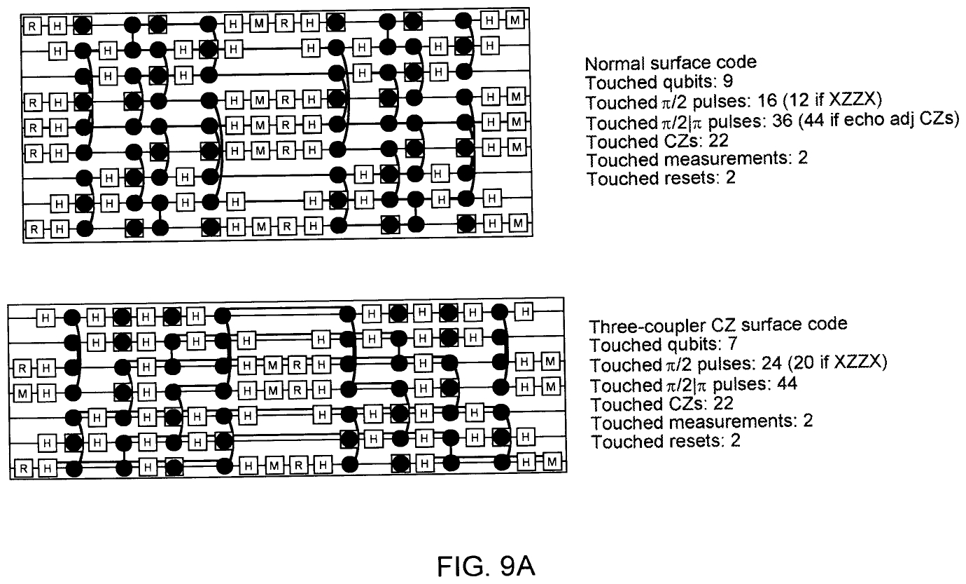

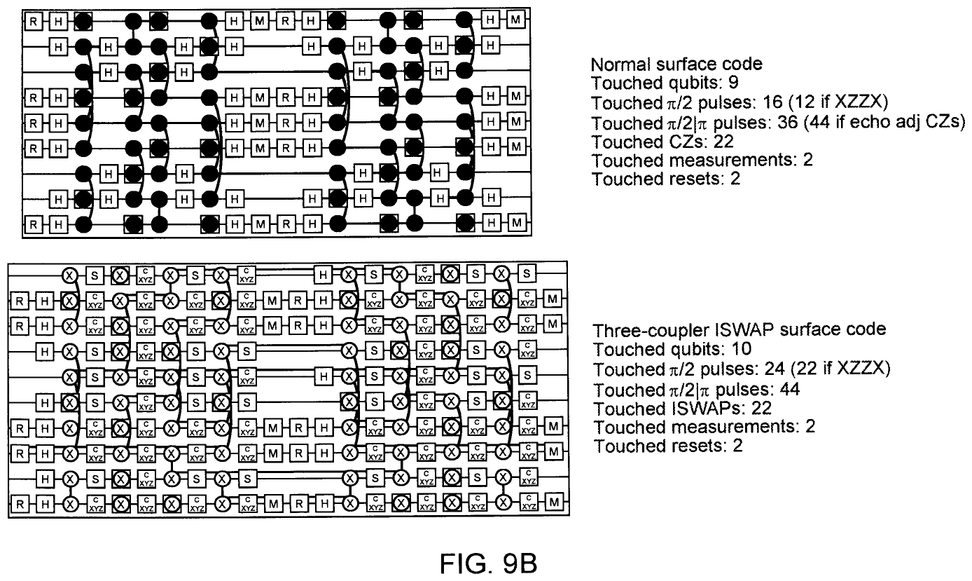

FIG. 9A compares the detection region of a conventional rotated surface code 900 and the presently described three coupler surface code 910 when implemented using CZ entangling operations. As shown, the presently described three coupler surface code touches less qubits than the conventional rotated surface code. The number of touched π/2 and π/2|π pulses are slightly larger than the conventional rotated surface code, but are still comparable. This slight increase does not significantly increase the complexity or cost of the process. The remaining metrics of interest are the same for both the conventional rotated surface code and the presently described three coupler surface code.

FIG. 9B compares the detection region of a conventional rotated surface code 920 and the presently described three coupler surface code 930 when implemented using iSWAP entangling operations. It can be beneficial in some cases to use iSWAP operations as entangling operations instead of CNOTs or CZs, e.g., because of the underlying hardware and control techniques used to operate the hardware. As shown, the presently described three coupler surface code touches one more qubit than the conventional rotated surface code. The number of touched π/2 and π/2|π pulses are slightly larger than the conventional rotated surface code, but are still comparable. The remaining metrics of interest are the same for both the conventional rotated surface code and the presently described three coupler surface code. Therefore, the detection regions are generally comparable.

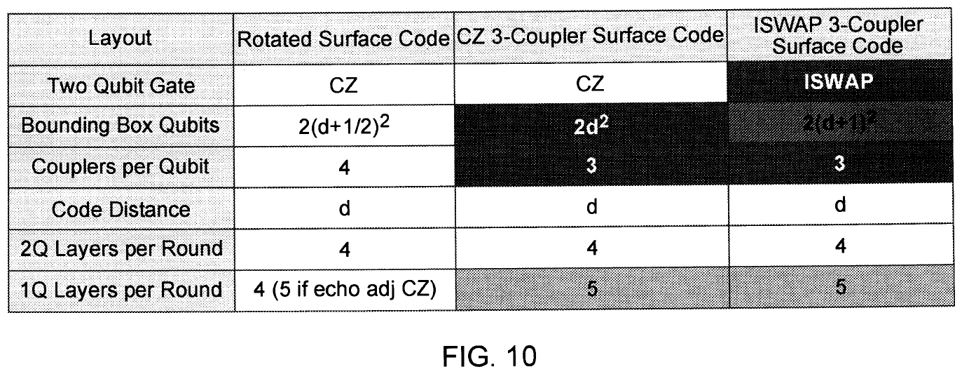

FIG. 10 shows a table 1000 that compares values of various surface code metrics for the conventional rotated surface code, the presently described three coupler surface code when implemented using CZ entangling operations, and the presently described three coupler surface code when implemented using iSWAP entangling operations. As shown, the presently described three coupler surface codes require less couplers per qubit, require less or similar bounding box qubits, have a same code distance, same number of 2Q layers per round, and comparable numbers of 1Q layers per round.

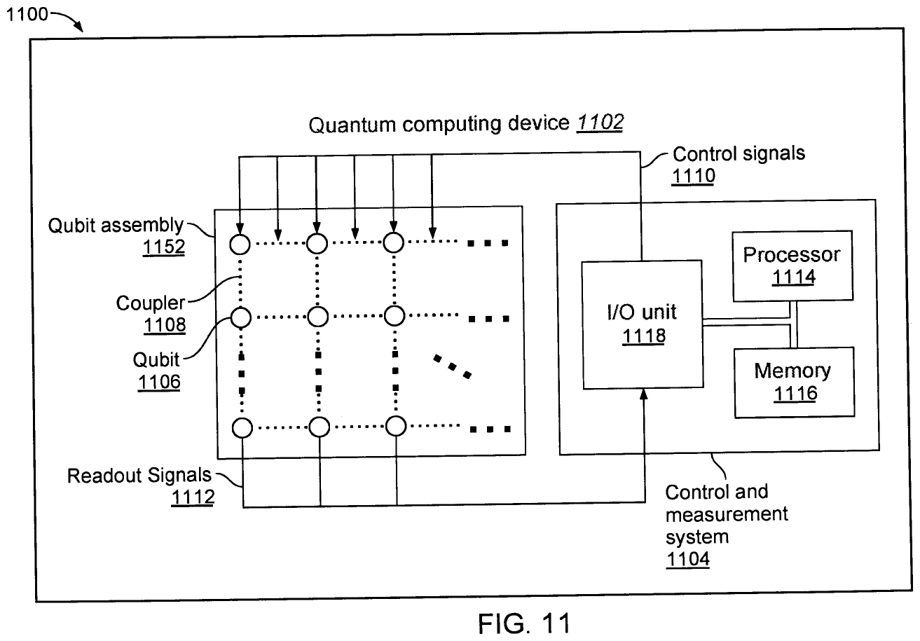

FIG. 11 depicts an example quantum computer 1100 for performing the quantum operations described in this specification. The example quantum computer 1100 includes an example quantum computing device 1102. The quantum computing device 1102 is intended to represent various forms of quantum computing devices. The components shown here, their connections and relationships, and their functions, are exemplary only, and do not limit implementations of the inventions described and/or claimed in this document.

The example quantum computing device 1102 includes a qubit assembly 1152 and a control and measurement system 1104. The qubit assembly 1152 includes multiple physical qubits, e.g., qubit 1106, that are used to perform algorithmic operations or quantum computations. While the qubits shown in FIG. 11 are arranged in a rectangular array, this is a schematic depiction and is not intended to be limiting. The qubit assembly 1152 also includes adjustable coupling elements, e.g., coupler 1108, that allow for interactions between coupled qubits. In the schematic depiction of FIG. 11, each qubit is adjustably coupled to each of its four adjacent qubits by means of respective coupling elements. However, this is an example arrangement of qubits and couplers and other arrangements are possible, including arrangements that are non-rectangular, arrangements that allow for coupling between non-adjacent qubits, and arrangements that include adjustable coupling between more than two qubits.

Each qubit can be a physical two-level quantum system or device having levels representing logical values of 0 and 1. The specific physical realization of the multiple qubits and how they interact with one another is dependent on a variety of factors including the type of the quantum computing device 1102 included in the example computer 1100 or the type of quantum computations that the quantum computing device is performing. For example, in an atomic quantum computer the qubits may be realized via atomic, molecular or solid-state quantum systems, e.g., hyperfine atomic states. As another example, in a superconducting quantum computer the qubits may be realized via superconducting qubits or semi-conducting qubits, e.g., superconducting transmon states. As another example, in a NMR quantum computer the qubits may be realized via nuclear spin states.

In some implementations a quantum computation can proceed by loading qubits, e.g., from a quantum memory, and applying a sequence of unitary operators to the qubits. Applying a unitary operator to the qubits can include applying a corresponding sequence of quantum logic gates to the qubits, e.g., to implement the surface code circuits described in this specification. Example quantum logic gates include single-qubit gates, e.g., Pauli-X, Pauli-Y, Pauli-Z (also referred to as X, Y, Z), Hadamard gates, S gates, rotations, two-qubit gates, e.g., controlled-X, controlled-Y, controlled-Z (also referred to as CX, CY, CZ), controlled NOT gates (also referred to as CNOT) controlled swap gates (also referred to as CSWAP), iSWAP gates, and gates involving three or more qubits, e.g., Toffoli gates. The quantum logic gates can be implemented by applying control signals 1110 generated by the control and measurement system 1104 to the qubits and to the couplers.

For example, in some implementations the qubits in the qubit assembly 1152 can be frequency tunable. In these examples, each qubit can have associated operating frequencies that can be adjusted through application of voltage pulses via one or more drive-lines coupled to the qubit. Example operating frequencies include qubit idling frequencies, qubit interaction frequencies, and qubit readout frequencies. Different frequencies correspond to different operations that the qubit can perform. For example, setting the operating frequency to a corresponding idling frequency may put the qubit into a state where it does not strongly interact with other qubits, and where it may be used to perform single-qubit gates. As another example, in cases where qubits interact via couplers with fixed coupling, qubits can be configured to interact with one another by setting their respective operating frequencies at some gate-dependent frequency detuning from their common interaction frequency. In other cases, e.g., when the qubits interact via tunable couplers, qubits can be configured to interact with one another by setting the parameters of their respective couplers to enable interactions between the qubits and then by setting the qubit's respective operating frequencies at some gate-dependent frequency detuning from their common interaction frequency. Such interactions may be performed in order to perform multi-qubit gates.

The type of control signals 1110 used depends on the physical realizations of the qubits. For example, the control signals may include RF or microwave pulses in an NMR or superconducting quantum computer system, or optical pulses in an atomic quantum computer system.

A quantum computation can be completed by measuring the states of the qubits, e.g., using a quantum observable such as X or Z, using respective control signals 1110. The measurements cause readout signals 1112 representing measurement results to be communicated back to the measurement and control system 1104. The readout signals 1112 may include RF, microwave, or optical signals depending on the physical scheme for the quantum computing device and/or the qubits. For convenience, the control signals 1110 and readout signals 1112 shown in FIG. 11 are depicted as addressing only selected elements of the qubit assembly (i.e., the top and bottom rows), but during operation the control signals 1110 and readout signals 1112 can address each element in the qubit assembly 1152.

The control and measurement system 1104 is an example of a classical computer system that can be used to perform various operations on the qubit assembly 1152, as described above, as well as other classical subroutines or computations. The control and measurement system 1104 includes one or more classical processors, e.g., classical processor 1114, one or more memories, e.g., memory 1116, and one or more I/O units, e.g., I/O unit 1118, connected by one or more data buses. The control and measurement system 1104 can be programmed to send sequences of control signals 1110 to the qubit assembly, e.g., to carry out a selected series of quantum gate operations, and to receive sequences of readout signals 1112 from the qubit assembly, e.g., as part of performing measurement operations.

The processor 1114 is configured to process instructions for execution within the control and measurement system 1104. In some implementations, the processor 1114 is a single-threaded processor. In other implementations, the processor 1114 is a multi-threaded processor. The processor 1114 is capable of processing instructions stored in the memory 1116.

The memory 1116 stores information within the control and measurement system 1104. In some implementations, the memory 1116 includes a computer-readable medium, a volatile memory unit, and/or a non-volatile memory unit. In some cases, the memory 1116 can include storage devices capable of providing mass storage for the system 1104, e.g., a hard disk device, an optical disk device, a storage device that is shared over a network by multiple computing devices (e.g., a cloud storage device), and/or some other large capacity storage device.

The input/output device 1118 provides input/output operations for the control and measurement system 1104. The input/output device 1118 can include D/A converters, A/D converters, and RF/microwave/optical signal generators, transmitters, and receivers, whereby to send control signals 1110 to and receive readout signals 1112 from the qubit assembly, as appropriate for the physical scheme for the quantum computer. In some implementations, the input/output device 1118 can also include one or more network interface devices, e.g., an Ethernet card, a serial communication device, e.g., an RS-232 port, and/or a wireless interface device, e.g., an 802.11 card. In some implementations, the input/output device 1118 can include driver devices configured to receive input data and send output data to other external devices, e.g., keyboard, printer, and display devices.

Although an example control and measurement system 1104 has been depicted in FIG. 11, implementations of the subject matter and the functional operations described in this specification can be implemented in other types of digital electronic circuitry, or in computer software, firmware, or hardware, including the structures disclosed in this specification and their structural equivalents, or in combinations of one or more of them.

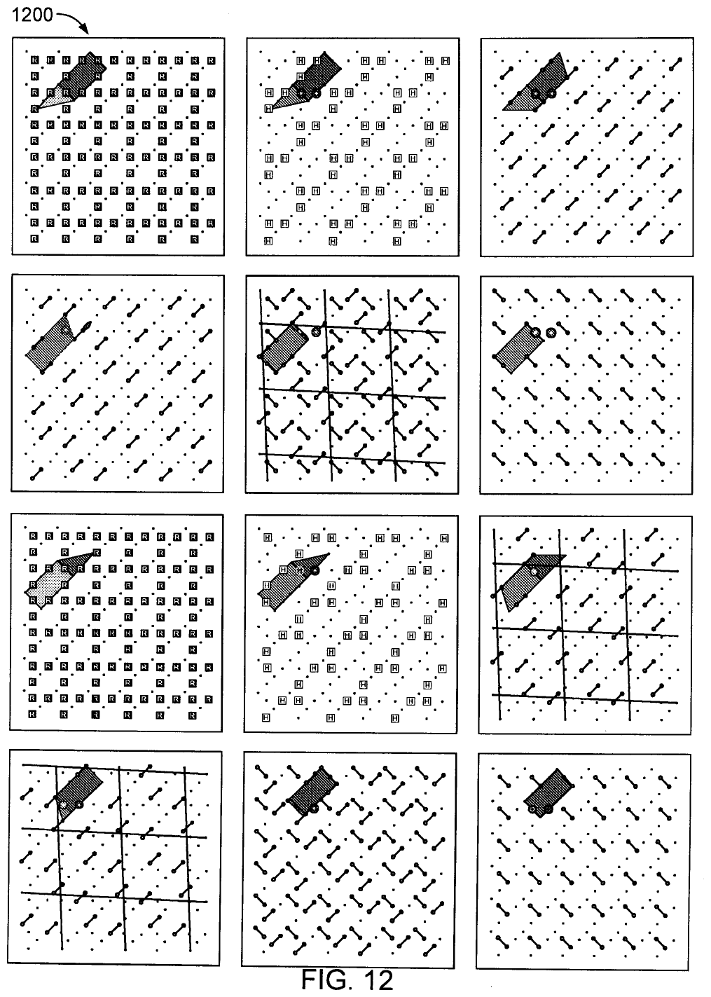

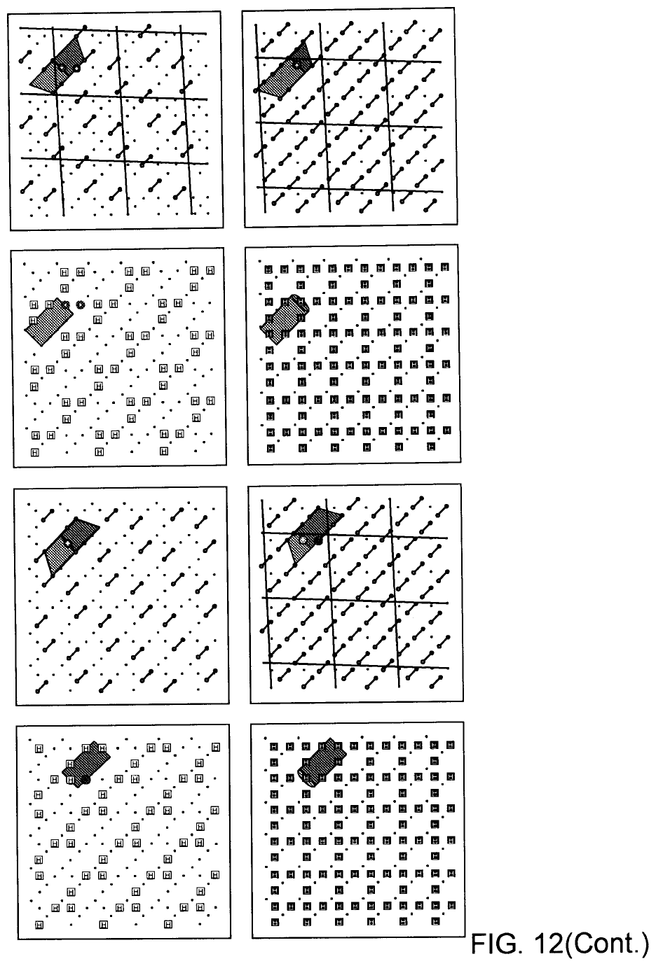

FIGS. 12-17 illustrate example circuit schedules for performing surface code cycles using the techniques described in the present disclosure. In each of the example circuit schedules, shaded areas illustrate how surface code stabilizers deform and change during the surface code cycle. Further, in each of the example circuit schedules, the schedule begins with an upper left tile (which typically corresponds to a reset stage) and proceeds through the rows from left to right. In each tile, “R” represents a reset operations on a respective qubit, “H” represents a Hadamard gate applied to a respective qubit, a two-qubit entangling operation is represented by two connected circles, e.g., a hollow circle (e.g., a target) connected to a filled circle (e.g., a control), and “S” represents an S gate applied to a respective qubit, “M” represents a measurement operation.

FIG. 12 shows a surface code circuit laid out on a donut (TORIC) using a hex grid with an additional qubit on each edge (HEAVY) built with CX gates (CX).

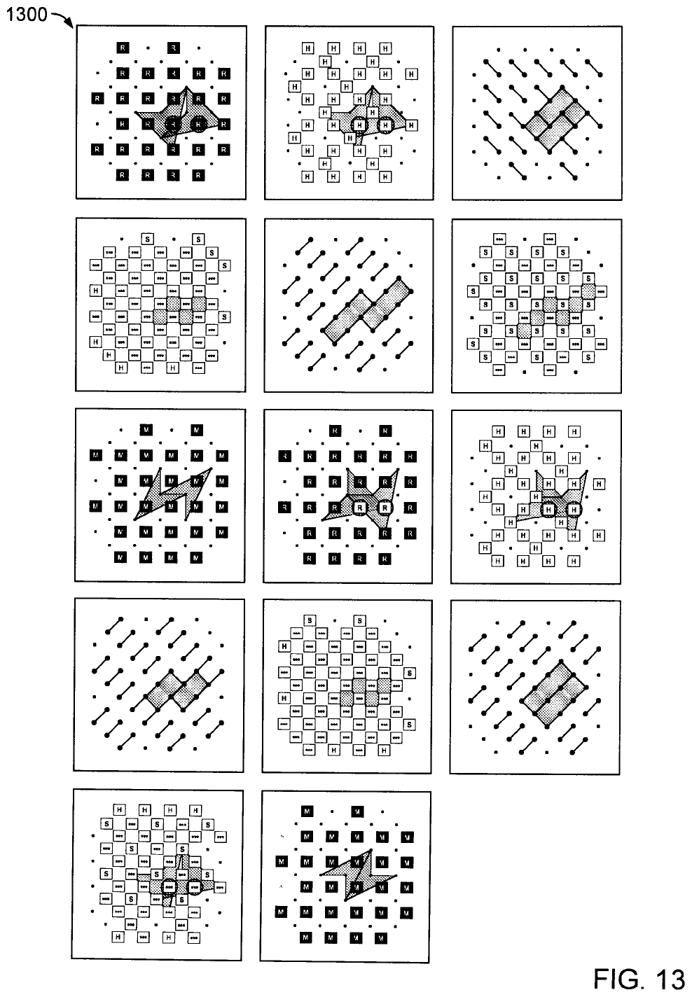

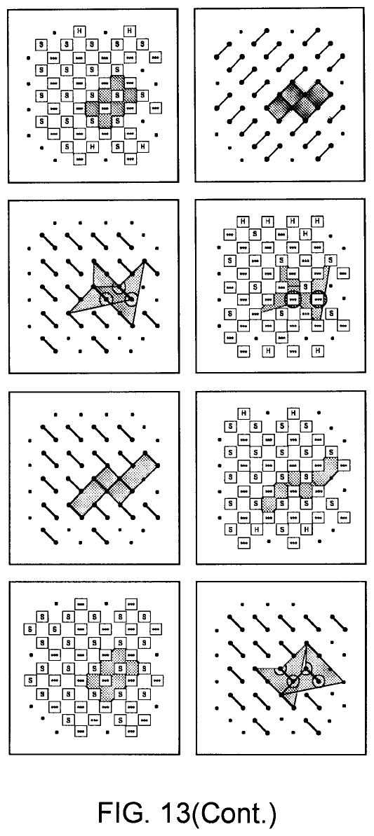

FIG. 13 shows a surface code circuit laid out on a plane ( ) using a hex grid (3) built with ISWAP gates (ISWAP).

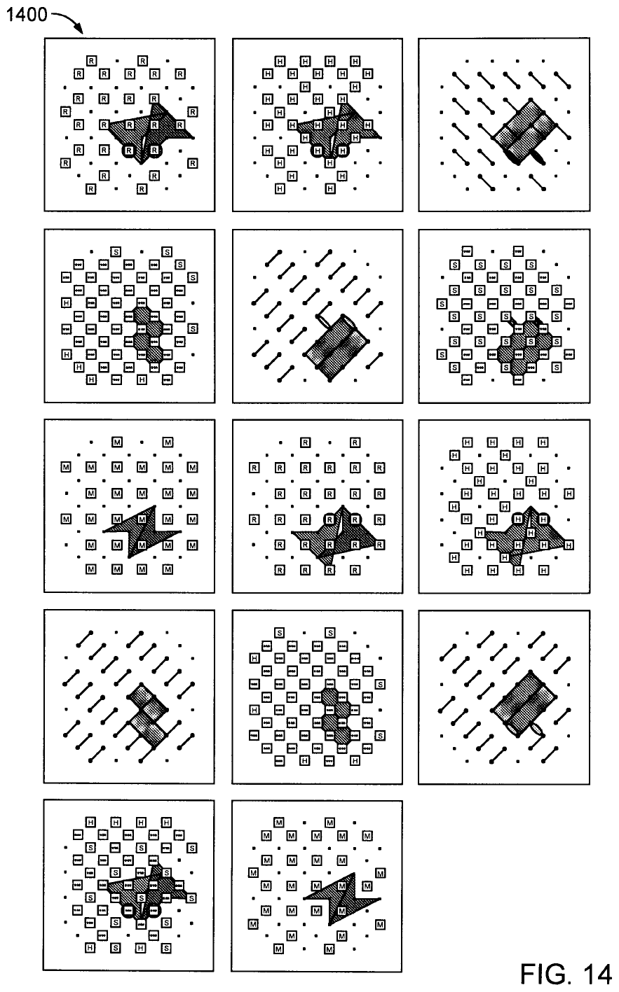

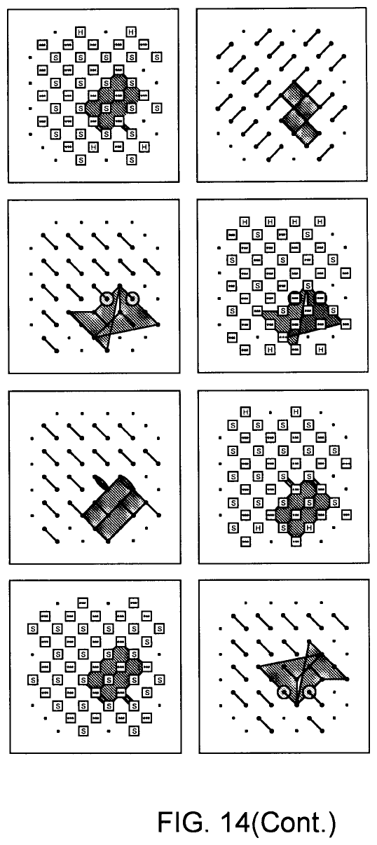

FIG. 14 shows a surface code circuit laid out on a plane ( ) using a hex grid (3) built with ISWAP gates (ISWAP) with alternation of which qubit sub-grid is measured (wiggle).

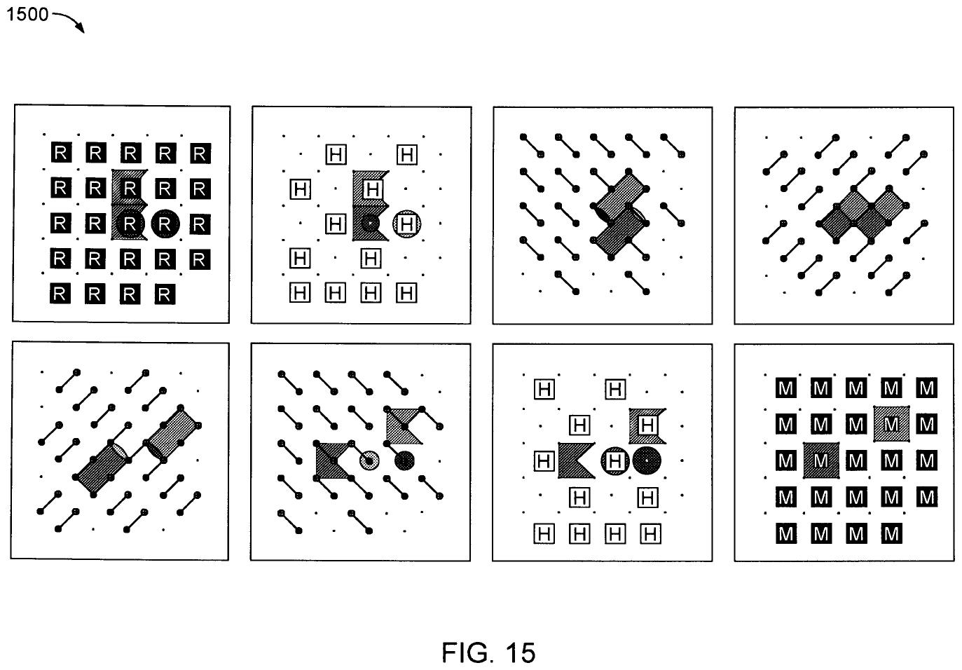

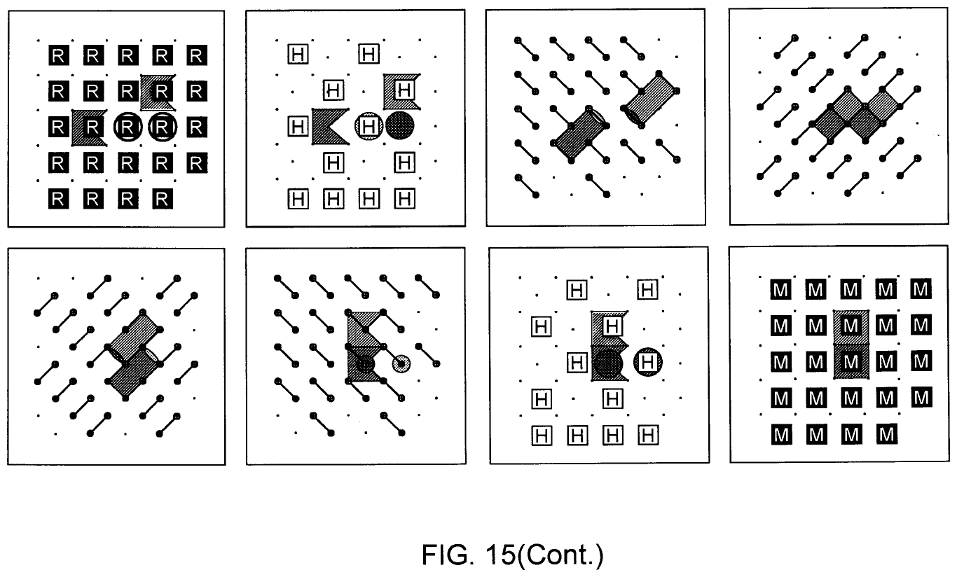

FIG. 15 shows a surface code circuit laid out on a plane ( ) using a hex grid (3) built with CX gates (CX).

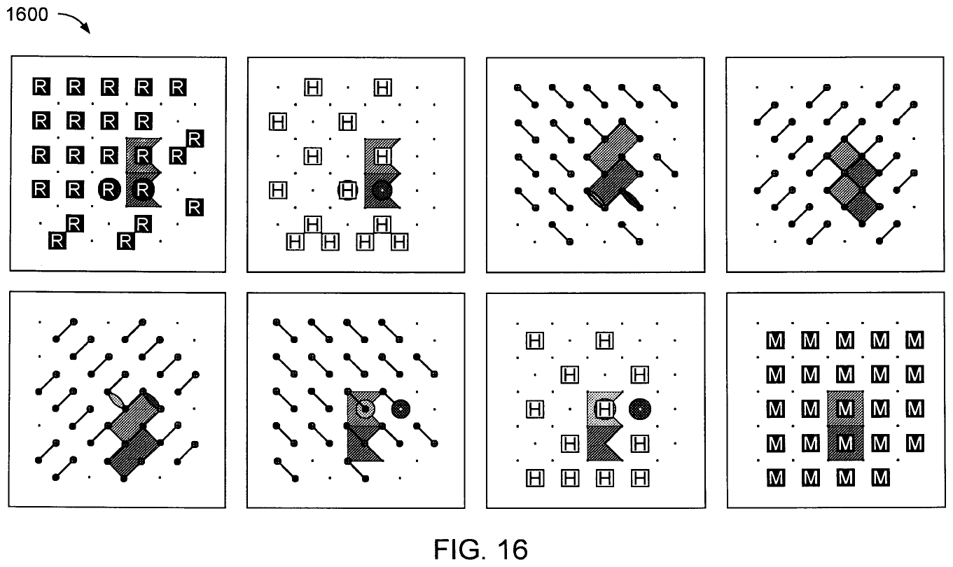

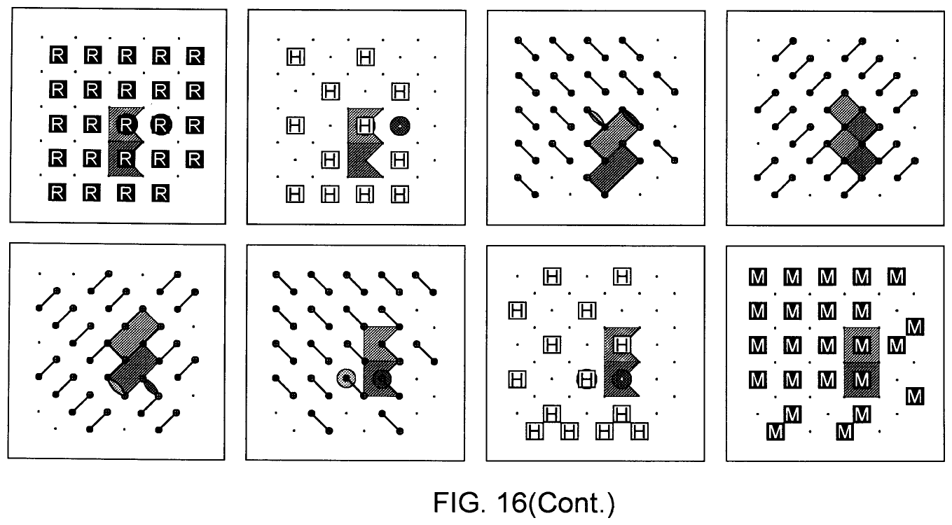

FIG. 16 shows a surface code circuit laid out on a plane ( ) using a hex grid (3) built with CX gates (CX) with alternation of which qubit sub-grid is measured (wiggle).

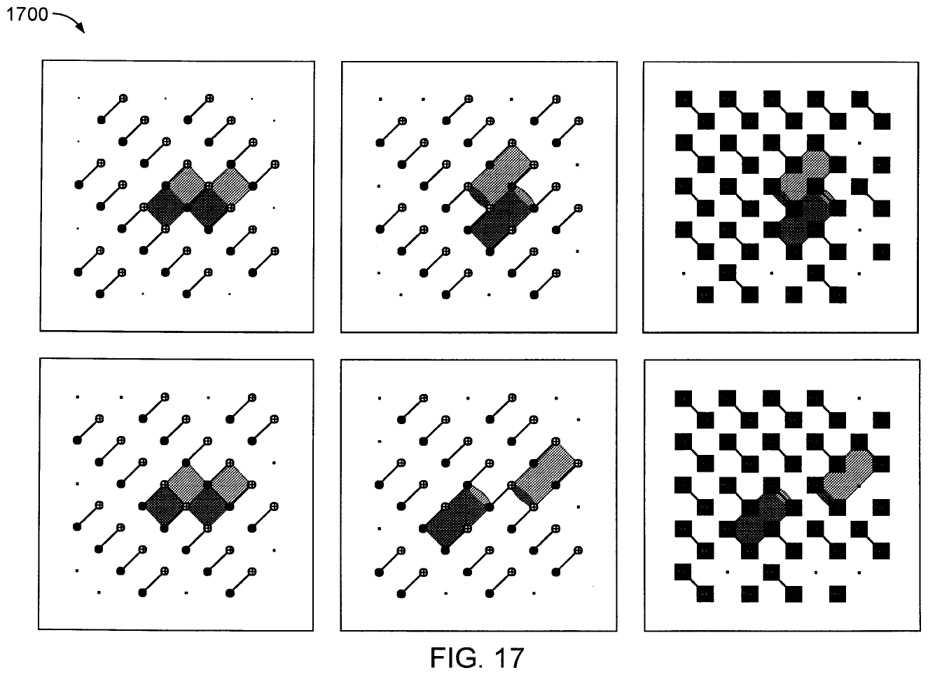

FIG. 17 shows a surface code circuit laid out on a plane ( ) using a hex grid (3) built with a combination of CX and parity measurement gates (CX_MXX_MZZ). In this example, the whole surface code cycle fits into three layers (assuming that it is possible to build hardware with these multiple kinds of interactions.)

Implementations of the subject matter and operations described in this specification can be implemented in digital electronic circuitry, analog electronic circuitry, suitable quantum circuitry or, more generally, quantum computational systems, in tangibly-embodied software or firmware, in computer hardware, including the structures disclosed in this specification and their structural equivalents, or in combinations of one or more of them. The term “quantum computational systems” may include, but is not limited to, quantum computers, quantum information processing systems, quantum cryptography systems, or quantum simulators.

Implementations of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, one or more qubits, or a combination of one or more of them. Alternatively, or in addition, the program instructions can be encoded on an artificially-generated propagated signal that is capable of encoding digital and/or quantum information, e.g., a machine-generated electrical, optical, or electromagnetic signal, that is generated to encode digital and/or quantum information for transmission to suitable receiver apparatus for execution by a data processing apparatus.

The terms quantum information and quantum data refer to information or data that is carried by, held or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, multiple digital and quantum processors or computers, and combinations thereof. The apparatus can also be, or further include, special purpose logic circuitry, e.g., an FPGA (field programmable gate array), an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL or Quipper.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable computers, operating with one or more processors, as appropriate, executing one or more computer programs to perform functions by operating on input data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more computers to be “configured to” perform particular operations or actions means that the system has installed on its software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For example, a quantum computer may receive instructions from a digital computer that, when executed by the quantum computing apparatus, cause the apparatus to perform the operations or actions.

Computers suitable for the execution of a computer program can be based on general or special purpose processors, or any other kind of central processing unit. Generally, a central processing unit will receive instructions and data from a read-only memory, a random access memory, or quantum systems suitable for transmitting quantum data, e.g. photons, or combinations thereof.

The elements of a computer include a central processing unit for performing or executing instructions and one or more memory devices for storing instructions and digital, analog, and/or quantum data. The central processing unit and the memory can be supplemented by, or incorporated in, special purpose logic circuitry or quantum simulators. Generally, a computer will also include, or be operatively coupled to receive data from or transfer data to, or both, one or more mass storage devices for storing data, e.g., magnetic, magneto-optical disks, optical disks, or quantum systems suitable for storing quantum information. However, a computer need not have such devices.

Quantum circuit elements (also referred to as quantum computing circuit elements) include circuit elements for performing quantum processing operations. That is, the quantum circuit elements are configured to make use of quantum-mechanical phenomena, such as superposition and entanglement, to perform operations on data in a non-deterministic manner. Certain quantum circuit elements, such as qubits, can be configured to represent and operate on information in more than one state simultaneously. Examples of superconducting quantum circuit elements include circuit elements such as quantum LC oscillators, qubits (e.g., flux qubits, phase qubits, or charge qubits), and superconducting quantum interference devices (SQUIDs) (e.g., RF-SQUID or DC-SQUID), among others.

In contrast, classical circuit elements generally process data in a deterministic manner. Classical circuit elements can be configured to collectively carry out instructions of a computer program by performing basic arithmetical, logical, and/or input/output operations on data, in which the data is represented in analog or digital form. In some implementations, classical circuit elements can be used to transmit data to and/or receive data from the quantum circuit elements through electrical or electromagnetic connections. Examples of classical circuit elements include circuit elements based on CMOS circuitry, rapid single flux quantum (RSFQ) devices, reciprocal quantum logic (RQL) devices and ERSFQ devices, which are an energy-efficient version of RSFQ that does not use bias resistors.

In certain cases, some or all of the quantum and/or classical circuit elements may be implemented using, e.g., superconducting quantum and/or classical circuit elements. Fabrication of the superconducting circuit elements can entail the deposition of one or more materials, such as superconductors, dielectrics and/or metals. Depending on the selected material, these materials can be deposited using deposition processes such as chemical vapor deposition, physical vapor deposition (e.g., evaporation or sputtering), or epitaxial techniques, among other deposition processes. Processes for fabricating circuit elements described herein can entail the removal of one or more materials from a device during fabrication. Depending on the material to be removed, the removal process can include, e.g., wet etching techniques, dry etching techniques, or lift-off processes. The materials forming the circuit elements described herein can be patterned using known lithographic techniques (e.g., photolithography or e-beam lithography).

During operation of a quantum computational system that uses superconducting quantum circuit elements and/or superconducting classical circuit elements, such as the circuit elements described herein, the superconducting circuit elements are cooled down within a cryostat to temperatures that allow a superconductor material to exhibit superconducting properties. A superconductor (alternatively superconducting) material can be understood as material that exhibits superconducting properties at or below a superconducting critical temperature. Examples of superconducting material include aluminum (superconductive critical temperature of 1.2 kelvin) and niobium (superconducting critical temperature of 9.3 kelvin). Accordingly, superconducting structures, such as superconducting traces and superconducting ground planes, are formed from material that exhibits superconducting properties at or below a superconducting critical temperature.

In certain implementations, control signals for the quantum circuit elements (e.g., qubits and qubit couplers) may be provided using classical circuit elements that are electrically and/or electromagnetically coupled to the quantum circuit elements. The control signals may be provided in digital and/or analog form.

Computer-readable media suitable for storing computer program instructions and data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a computer program product that includes instructions that are stored on one or more non-transitory machine-readable storage media, and that are executable on one or more processing devices. The systems described in this specification, or portions of them, can each be implemented as an apparatus, method, or system that may include one or more processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for performing a surface code cycle using a quantum computer comprising a plurality of qubits, the method comprising:
for a data qubit in the plurality of qubits that is coupled to three measure qubits in the plurality of qubits, wherein the data qubit is coupled to a first measure qubit by a first qubit coupler, a second measure qubit by a second qubit coupler, and a third measure qubit by a third qubit coupler;
measuring a first surface code stabilizer, comprising performing a first set of entangling operations between the data qubit and the first measure qubit using the first qubit coupler;
measuring a second surface code stabilizer, comprising performing a second set of entangling operations between the data qubit and the second measure qubit using the second qubit coupler;
measuring a third surface code stabilizer, comprising performing a third set of entangling operations between the data qubit and the third measure qubit using the third qubit coupler; and
measuring a fourth surface code stabilizer, comprising performing a fourth set of entangling operations between the data qubit and the second measure qubit using the second qubit coupler.

2. The method of claim 1, wherein the first surface code stabilizer, the second surface code stabilizer, the third surface code stabilizer, and the fourth surface code stabilizer comprise ZZZZ or XXXX stabilizers.

3. The method of claim 1, wherein the first, second, third, and fourth set of entangling operations comprise CNOT operations.

4. The method of claim 1, wherein the first, second, third, and fourth set of entangling operations comprise CNOT operations and SWAP gates.

5. The method of claim 1, wherein the plurality of qubits is arranged as a hexagonal grid.

6. The method of claim 1, wherein the plurality of qubits is arranged as a square grid.

7. The method of claim 1, wherein the data qubit comprises a bulk data qubit.

8. The method of claim 1, wherein the first surface code stabilizer is measured in parallel to the second surface code stabilizer.

9. The method of claim 1, wherein the third surface code stabilizer is measured in parallel to the fourth surface code stabilizer and subsequent to the first surface code stabilizer and the second surface code stabilizer.

10. The method of claim 1, wherein at least one of the first, second, third, or fourth surface code stabilizers comprise a ZZZZ stabilizer, and wherein measuring the ZZZZ stabilizer comprises:
performing a first CNOT gate on a first data qubit and a second data qubit, wherein the first data qubit acts as a control;
performing a second CNOT gate on a third data qubit and a measure qubit for the ZZZZ stabilizer, wherein the third data qubit acts as a control;
performing a third CNOT gate on the second data qubit and the measure qubit for the ZZZZ stabilizer, wherein the second data qubit acts as a control;
measuring the measure qubit for the ZZZZ stabilizer in the Z basis;
performing a fourth CNOT gate on the second data qubit and the measure qubit for the ZZZZ stabilizer, wherein the second data qubit acts as a control;
performing a fifth CNOT gate on the third data qubit and the measure qubit for the ZZZZ stabilizer, wherein the third data qubit acts as a control; and
performing a sixth CNOT gate on the first data qubit and the second data qubit, wherein the first data qubit acts as a control;
wherein the data qubit in the plurality of qubits is either the first, second, or third data qubit.

11. The method of claim 1, wherein at least one of the first, second, third, or fourth surface code stabilizers comprise a XXXX stabilizer, and wherein measuring the XXXX stabilizer comprises:
performing a first CNOT gate on a measure qubit for the XXXX stabilizer and a first data qubit, wherein the measure qubit for the XXXX stabilizer acts as a control;
performing a second CNOT gate on a second data qubit and a third data qubit, wherein the second data qubit acts as a control;
performing a third CNOT gate on the measure qubit for the XXXX stabilizer and the second data qubit, wherein the measure qubit for the XXXX stabilizer acts as a control;
measuring the measure qubit for the XXXX stabilizer in the X basis;
performing a fourth CNOT gate on the measure qubit for the XXXX stabilizer and the second data qubit, wherein the measure qubit for the XXXX stabilizer acts as a control;
performing a fifth CNOT gate on the second data qubit and the third data qubit, wherein the second data qubit acts as a control; and
performing a sixth CNOT gate on the measure qubit for the XXXX stabilizer and the first data qubit, wherein the measure qubit for the XXXX stabilizer acts as a control;
wherein the data qubit in the plurality of qubits is either the first, second, or third data qubit.

12. The method of claim 1, wherein at least one of the first, second, third, or fourth surface code stabilizers comprise a XXXX stabilizer and at least one of the first, second, third, or fourth surface code stabilizers comprise a ZZZZ stabilizer, wherein measuring the XXXX stabilizer and the ZZZZ stabilizer comprises:
performing a first CNOT gate on a first measure qubit and a first data qubit, wherein the first measure qubit acts as a control;
performing a second CNOT gate on a second data qubit and a third data qubit, wherein the second data qubit acts as a control;
performing a third CNOT gate on a fourth data qubit and a second measure qubit, wherein the fourth data qubit acts as a control;
performing a fourth CNOT gate on the first measure qubit and the second data qubit, wherein the first measure qubit acts as a control;
performing a fifth CNOT gate on the third data qubit and the second measure qubit, wherein the third data qubit acts as a control;
measuring the first measure qubit in the X basis and the second measure qubit in the Z basis;
performing a sixth CNOT gate on the third data qubit and the second measure qubit, wherein the third data qubit acts as a control;
performing a seventh CNOT gate on the first measure qubit and the second data qubit, wherein the first measure qubit acts as a control;
performing an eighth CNOT gate on the fourth data qubit and the second measure qubit, wherein the fourth data qubit acts as a control;
performing a ninth CNOT gate on the second data qubit and the third data qubit, wherein the second data qubit acts as a control; and
performing a tenth CNOT gate on the first measure qubit and the first data qubit, wherein the first measure qubit acts as a control;
wherein the data qubit in the plurality of qubits is either the first, second, third, or fourth data qubit the first measure qubit is a measure qubit for the XXXX stabilizer, and the second measure qubit is a measure qubit for the ZZZZ stabilizer.

13. A quantum computing apparatus comprising:
a plurality of physical qubits;
qubit couplers defining nearest neighbor interactions between the plurality of qubits; and
control electronics configured to operate the plurality of qubits and qubit couplers, wherein the control electronics are configured to perform operations for implementing a surface code cycle, the operations comprising:
for a data qubit in the plurality of qubits that is coupled to three measure qubits in the plurality of qubits, wherein the data qubit is coupled to a first measure qubit by a first qubit coupler, a second measure qubit by a second qubit coupler, and a third measure qubit by a third qubit coupler;
measuring a first surface code stabilizer, comprising performing a first set of entangling operations between the data qubit and the first measure qubit using the first qubit coupler;
measuring a second surface code stabilizer, comprising performing a second set of entangling operations between the data qubit and the second measure qubit using the second qubit coupler;
measuring a third surface code stabilizer, comprising performing a third set of entangling operations between the data qubit and the third measure qubit using the third qubit coupler; and
measuring a fourth surface code stabilizer, comprising performing a fourth set of entangling operations between the data qubit and the second measure qubit using the second qubit coupler.

14. A method for performing a surface code cycle, the method comprising:
for a quantum computer comprising an array qubits, wherein each qubit in the array of qubits is coupled to at most three other qubits in the array of qubits:
measuring a first column of alternating XXXX and ZZZZ stabilizers in the array of qubits;
measuring a second column of alternating XXXX and ZZZZ stabilizers in the array of qubits, wherein the second column is adjacent to the first column and the XXXX and ZZZZ stabilizer measurements in the second column vertically mirror the XXXX and ZZZZ stabilizer measurements in the first column.

15. A quantum computing apparatus comprising:
a plurality of physical qubits;
qubit couplers defining nearest neighbor interactions between the plurality of qubits; and
control electronics configured to operate the plurality of qubits and qubit couplers, wherein the control electronics are configured to perform operations for implementing a surface code cycle, the operations comprising:
for a quantum computer comprising an array qubits, wherein each qubit in the array of qubits is coupled to at most three other qubits in the array of qubits:
measuring a first column of alternating XXXX and ZZZZ stabilizers in the array of qubits;
measuring a second column of alternating XXXX and ZZZZ stabilizers in the array of qubits, wherein the second column is adjacent to the first column and the XXXX and ZZZZ stabilizer measurements in the second column vertically mirror the XXXX and ZZZZ stabilizer measurements in the first column.
